(19) United States
(12) Patent Application Publication
(10) Pub. No.: US 2003/0102351 A1
(43) Pub. Date: Jun. 5, 2003

(54) NAIL-LOADING STRUCTURE OF A NAIL MAGAZINE

(76) Inventor: Cheng-Tsung Cheng, Tai-Ping City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/000,308

(22) Filed: Dec. 4, 2001

(51) Int. Cl. B25C 5/02

(52) U.S. Cl. 227/120

(57) ABSTRACT

A nail-loading structure of a nail magazine. One end of the nail magazine is formed with an opening. One side of the opening adjacent to the nail-pushing seat is formed with a guiding slope. The row of nails are pushed into the nail magazine along the guiding slope. The guiding slope serves to guide the row of nails to be smoothly pushed and loaded into the nail magazine. The nail-loading structure has simple components and enables a user to easily load the nails.

### BACKGROUND OF THE INVENTION

The present invention is related to a nail-loading structure of a nail magazine, which enables a user to easily load a row of nails into the nail magazine.

FIG. 6 shows a conventional nailing gun. The gun body 40 of the nailing gun includes a handle 41 and a head section 42 in which a nail magazine 43 is inserted. The nail magazine 43 is formed with a nail channel 44 for receiving therein a row of nails (not shown). When loading the nails into the nail magazine 43, a latch member 432 of a lateral cover 431 of the nail magazine 43 is first unlatched. Then the lateral cover 431 is pushed open to downward drive the nail-pushing plate 433. Then the row of nails are placed into the nail magazine 43 and the lateral cover 431 is pushed back. At this time, the lateral cover 431 drives the nail-pushing plate 433 to push the nails. Finally, the latch member 432 is latched.

The above procedure is quite troublesome. Moreover, when opening the lateral cover 431, the nail-pushing plate 433 is synchronously driven. The nail-pushing plate 433 suffers a pushing force of a spring (not shown) so that it is laborious for a user to open the lateral cover 431. Furthermore, after the nails are loaded in and when the nails are pushed by the nail-pushing plate 433, the nail magazine 43 is open so that the row of nails are likely to be arched due to compression of the nail-pushing plate 433. Accordingly, the row of nails will be located in incorrect position in the nail channel 44 and the user will be unable to perform the nailing operation.

FIGS. 7 and 8 show another type of nail magazine structure including a nail magazine 60, a pair of parallel walls and a latch member 63. The nail channel 601 of the nail magazine 60 is supported by a supporting body 61 to guide the nails 70 to move in the extending direction of the nail magazine 601. The two walls restrict the transverse direction of the nail channel 601. The first wall 621 is fixed on the supporting body 61, while the second wall 622 is longitudinally pivotally connected with the first wall 621. By means of opening the second wall 622, a user can transversely get close to at least a part of the nail channel 601. A latch member 63 fixes the second wall 622 at a position for closing the nail channel 601.

According to the above arrangement, after the second wall 622 is closed to mate with the first wall 621, the nail channel 601 is sealed so that the problem caused by compression of the nail-pushing plate 64 can be avoided. However, when loading in the nails, the user must first unlatch the latch member 63 and open the second wall 622 and then laboriously push the nail-pushing plate 64 backward. Then the user can load the nails 70 into the nail magazine. Thereafter, the user needs to close the second wall 622 and again latch the latch member 63. Such procedure is also complicated and troublesome. Furthermore, such structure has more components so that the manufacturing and assembling cost is increased.

### SUMMARY OF THE INVENTION

It is therefore a primary object of the present invention to provide a nail-loading structure of a nail magazine. When loading the nails, a user only needs to retract the nail-pushing plate into the nail-pushing seat and place in a new row of nails. Then the nail-pushing plate pushes and locate the row of nails in the nail channel of the nail magazine. Such operation is easy without consuming much strength.

It is a further object of the present invention to provide the above nail-loading structure of the nail magazine in which after the nails are loaded into the nail channel of the nail magazine, except the opening of the nail magazine, the nail magazine is closed. Therefore, the row of nails are restricted by the closed nail magazine and prevented from being outward arched due to compression of the nail-pushing plate.

It is still a further object of the present invention to provide the above nail-loading structure of the nail magazine in which the nail magazine is formed with an opening and a guiding slope is formed on one side of the opening. The row of nails are pushed into the nail magazine along the guiding slope. The guiding slope serves to guide the row of nails to be smoothly pushed and loaded into the nail magazine. Such structure has simple components so that the manufacturing cost is lowered.

The present invention can be best understood through the following description and accompanying drawings wherein:

### BRIEF DESCRIPTION OF THE DRAWINGS

FIG. 1 is a perspective assembled view of the present invention;

FIG. 2 is a side view of the nail magazine of the present invention;

FIG. 3 is a sectional view taken along line 3-3 of FIG. 1;

FIG. 4 is a sectional view according to FIG. 3, showing the nail-loading operation of the present invention;

FIG. 5 is a sectional view according to FIG. 3, showing that the row of nails are pressed inward;

FIG. 6 is a perspective view of a conventional nailing gun;

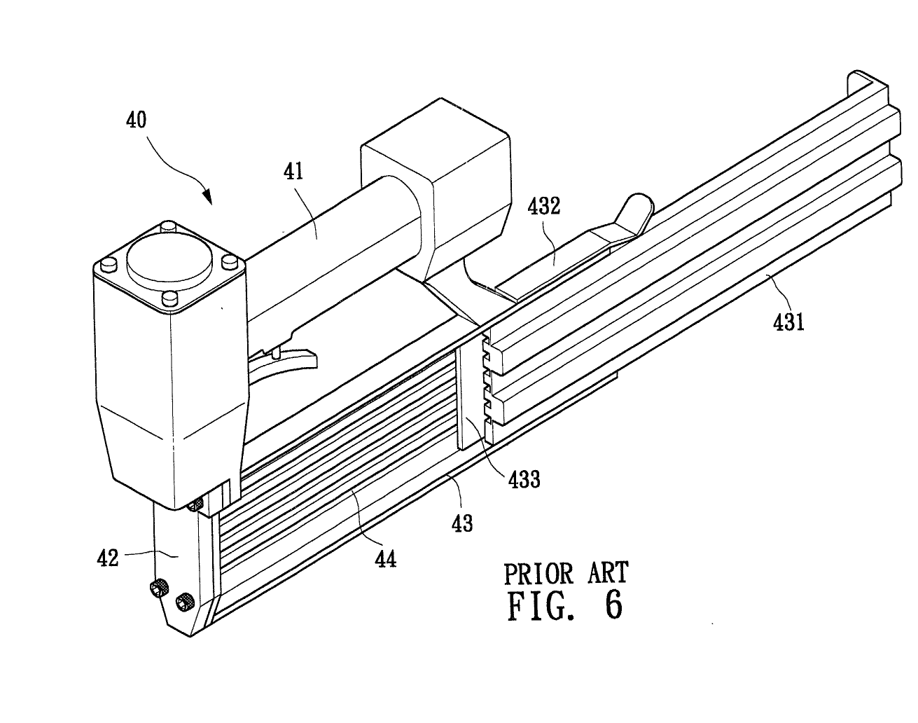

FIG. 7 is a side view of another type of conventional nailing gun; and

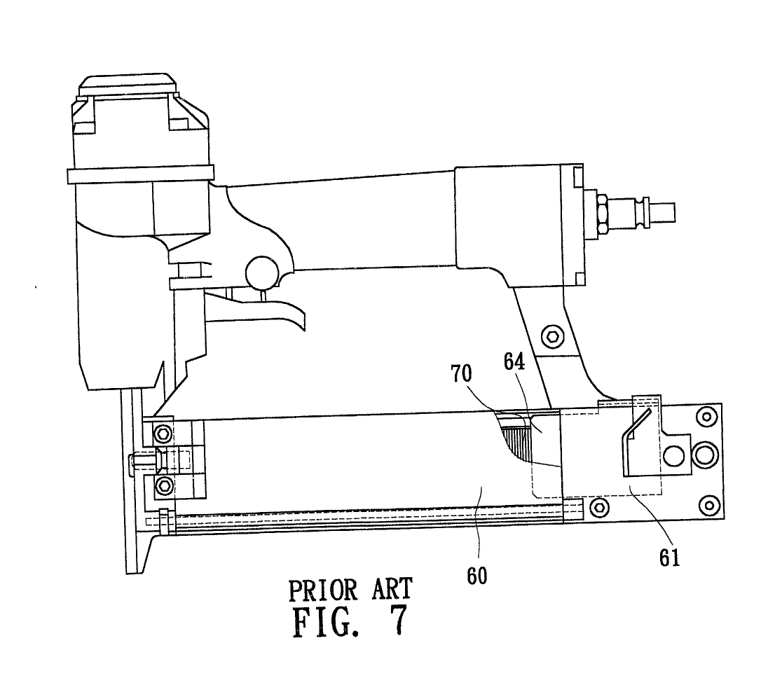

FIG. 8 is a top view according to FIG. 7.

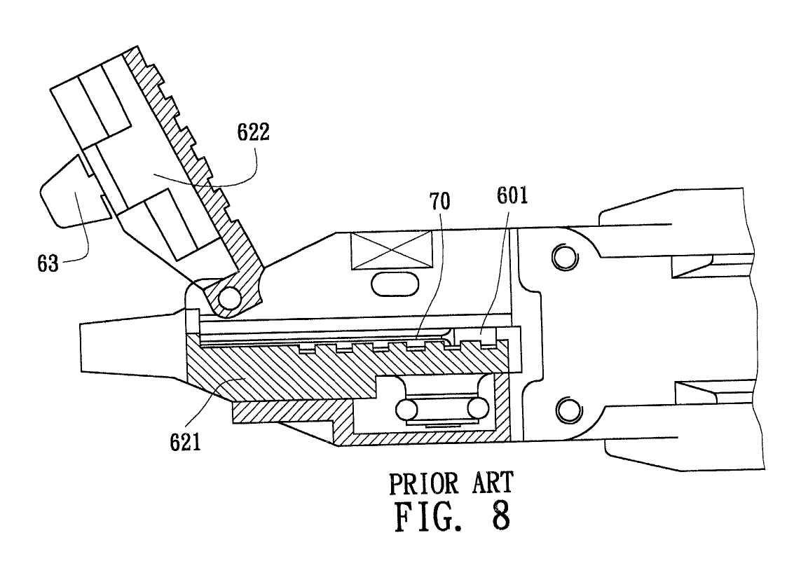

### DETAILED DESCRIPTION OF THE PREFERRED EMBODIMENTS

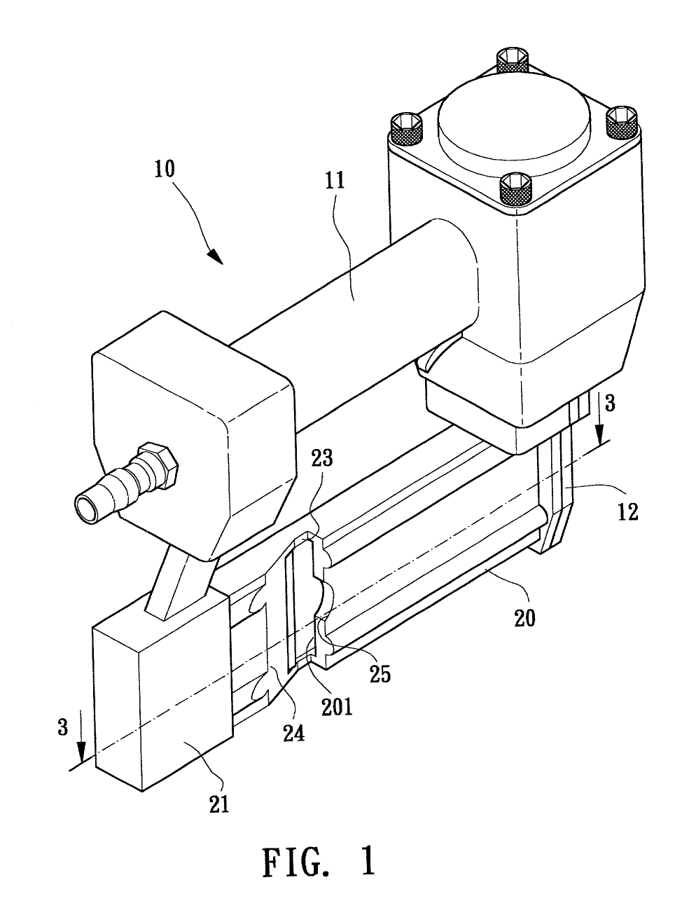

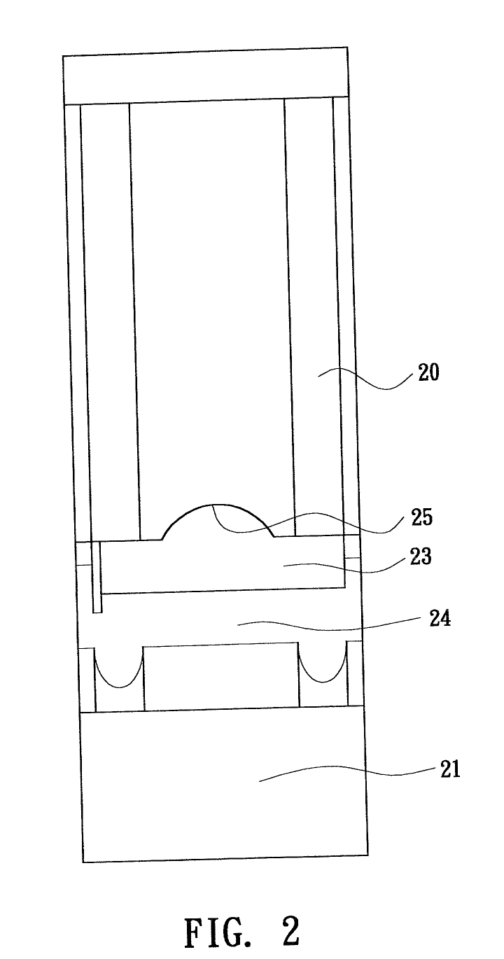

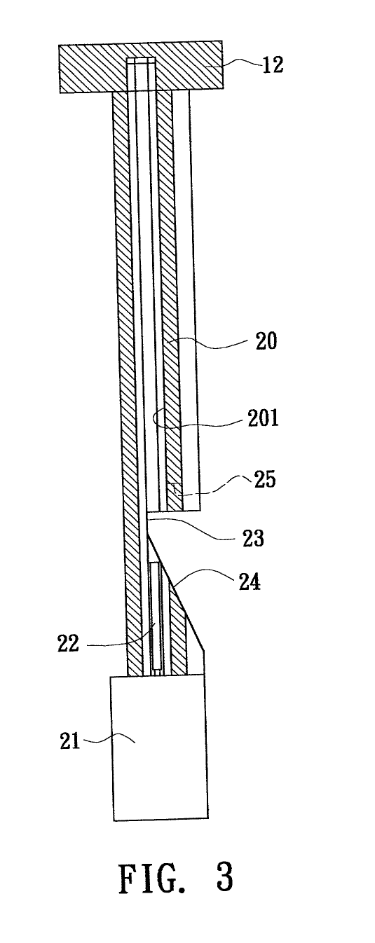

Please refer to FIGS. 1 to 3 which show the nail magazine structure of nailing gun of the present invention. The gun body 10 has a handle 11 and a head section 12. A nail magazine 20 is fixed under the head section 12. The nail magazine 20 is formed with a nail channel 201. A nail-pushing seat 21 is positioned on the bottom of the nail magazine 20 and fixed with the handle 11. A nail-pushing plate 22 is disposed in the nail-pushing seat 21. A row of nails 30 are loaded in the nail channel 201 and pushed by the nail-pushing plate 22.

One end of the nail magazine 20 distal from the head section 12 is formed with an opening 23. In this embodiment, the opening 23 is positioned on right side of the nail magazine 20, whereby a user can conveniently push the nails thereinto. One side of the opening 23 adjacent to the nail-pushing seat 21 is formed with a guiding slope 24 for guiding the nails 30 to enter the nail channel 201.

The other side of the opening 23 opposite to the guiding slope 24 is formed with an arched notch 25. A user's finger can extend through the notch 25 to push the nails 30 and make the nails 30 more smoothly enter the nail channel 201.

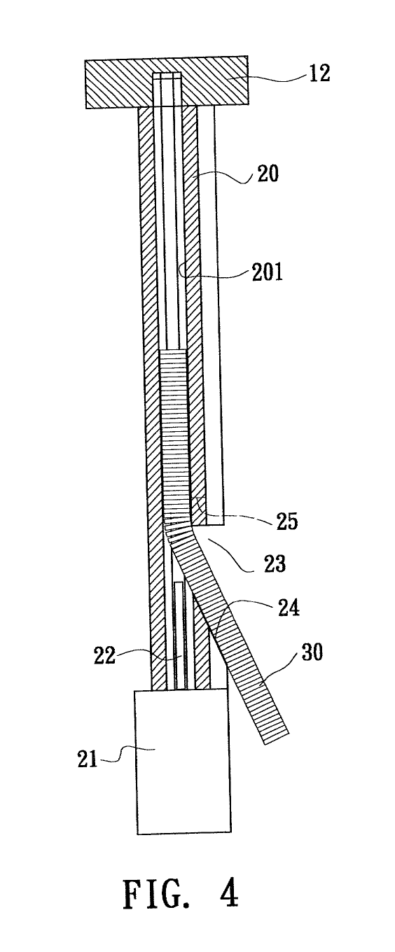

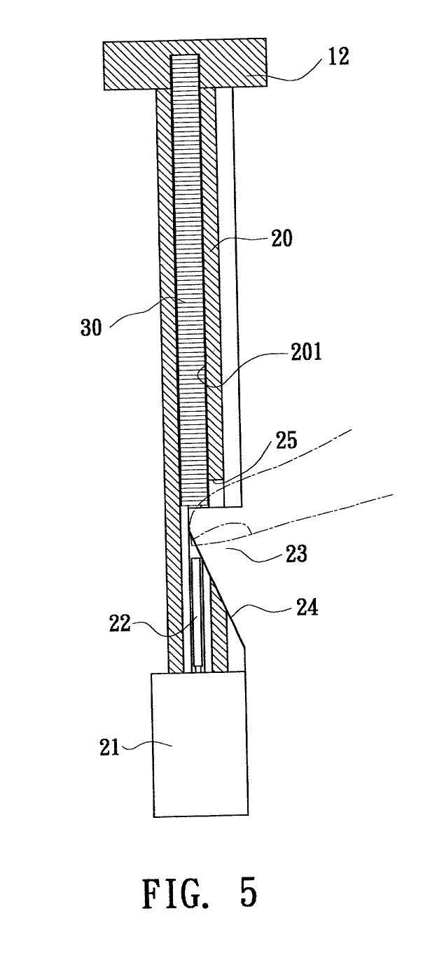

Referring to FIG. 4, when loading the nails 30 into the nail channel 201 of the nail magazine 20, a user first retracts the nail-pushing plate 22 along the nail channel 201 into the nail-pushing seat 21. At this time, the row of nails 30 can be placed into the nail magazine 20 from the right side opening 23 thereof. When placing in the nails 30, the guiding slope 24 guides the row of nails 30 to be smoothly pushed into the nail channel 201. The user's finger can extend through the notch 25 to push and press the row of nails 30 into the nail channel 201 as shown in FIG. 5. The nail-pushing plate 23 can along the nail channel 201 pushes the bottommost nail 30 in the nail magazine 20. Such operation is simple and convenient without wasting strength. Furthermore, after the nails 30 are loaded into the nail channel 201, except the opening 23 of the nail magazine 20, the nail magazine 20 is closed. Therefore, the row of nails 30 are restricted by the closed nail magazine 20 and prevented from being outward arched due to compression of the nail-pushing plate 22. Accordingly, the nailing operation can be normally performed.

The nail-pushing plate 22 can be driven by many measures. For example, the nail-pushing plate 22 can be pushed by resilient restoring force of a spring or pushed by a pneumatic cylinder.

In conclusion, the nailing gun of the present invention has the following advantages:

1. It is easy to load the nails into the nail magazine. When loading the nails, a user only needs to retract the nail-pushing plate into the nail-pushing seat and place in a new row of nails. Then the nail-pushing plate pushes and locate the row of nails in the nail channel of the nail magazine. Such operation is easy without consuming much strength.

2. The row of nails are prevented from being outward arched. After the nails are loaded into the nail channel of the nail magazine, except the opening of the nail magazine, the nail magazine is closed. Therefore, the row of nails are restricted by the closed nail magazine and prevented from being outward arched due to compression of the nail-pushing plate.

3. The present invention has simple components. The guiding slope on one side of the opening of the nail magazine serves to guide the row of nails to be smoothly pushed into the nail channel. Such structure has simple components so that the manufacturing cost is lowered.

The above embodiments are only used to illustrate the present invention, not intended to limit the scope thereof. Many modifications of the above embodiments can be made without departing from the spirit of the present invention.

What is claimed is:

1. A nail-loading structure of a nail magazine, the nail magazine being disposed on a gun body of a nailing gun, the gun body having a transverse handle and a head section at one end of the handle, the nail magazine being fixed on the head section in parallel to the handle, the nail magazine being formed with a nail channel in the same direction, a nail-pushing seat being disposed at one end of the nail magazine distal from the head section, a nail-pushing plate being disposed in the nail-pushing seat, the nail-pushing plate being extendable to push a row of nails loaded in the nail magazine, one side of one end of the nail magazine distal from the head section being formed with an opening communicating with the nail channel, one side of the opening adjacent to the nail-pushing seat being formed with a guiding slope, the guiding slope outward extending away from the head section, whereby the guiding slope and the nail channel contain an angle smaller than 90 degrees.

2. The nail-loading structure of a nail magazine as claimed in claim 1, wherein the other side of the opening opposite to the guiding slope is formed with an arched notch, whereby a user's finger can extend through the notch to push the row of nails and make the nails more smoothly enter the nail channel without dropping out due to inclination of the gun body.
